(19) United States
(12) Patent Application Publication
(10) Pub. No.: US 2007/0192765 A1
(43) Pub. Date: Aug. 16, 2007

(54) Virtual machine system

(75) Inventors: Kenichirou Shimogawa, Kawasaki (JP); Yoshihiko Oguchi, Kawasaki (JP); Masaki Kanno, Kawasaki (JP); Akio Takebe, Kawasaki (JP)

Correspondence Address: Patrick G. Burns;GREER, BURNS & CRAIN, LTD., Suite 2500, 300 South Wacker Dr., Chicago, IL, 60606, US

(73) Assignee: FUJITSU LIMITED

(21) Appl. No.: 11/441,779

(22) Filed: May 26, 2006

(30) Foreign Application Priority Data
Feb. 15, 2006 (JP) 2006-038557

(51) Int. Cl. G06F 9/455

(52) U.S. Cl. 718/1

(57) ABSTRACT

A virtual machine system managed by a current host OS virtually operating on hardware is provided that activates a spare host OS by copying the current host OS to a prescribed memory device using a live migration function when the current host OS is activated, notifies the spare host OS of a request issued to the current host OS via a virtual machine monitor, changes a state of the spare host OS, and switches an OS for managing the virtual machine system from the current host OS to the spare host OS, when the current host OS is in an erroneous state.

### BACKGROUND OF THE INVENTION

1. Field of the Invention

The present invention relates to a virtual machine system managed by a host OS that virtually operates on hardware.

2. Description of the Related Art

FIG. 1 shows a conventional virtual machine system.

A virtual machine system 160 shown in FIG. 1 includes a host Operating System (OS) 162 such as Windows, Linux or the like, guest OSs 163 such as Windows, Linux and the like, and driver OSs 164 which respectively operate as virtual machines (VMs) on hardware 161 including a Central Processing Unit (CPU) and the like, and a virtual machine monitor (VMM) 165 operating on the hardware 161 for controlling the respective operations of the host OS 162, the guest OSs 163, and the driver OSs 164.

The host OS 162 is an OS that operates as a domain of the virtual machines such as the guest OSs 163, the driver OSs 164 and the like, and that manages the guest OSs 163 and the driver OSs 164 while communicating with the virtual machine monitor 165. The host OS 162 is an OS that is automatically activated at the time of boot of the virtual machine system 160. The host OS 162 manages resources of the entire virtual machine system 160, allocates the resources and controls operations (activation, termination and the like) of the guest OSs 163 and the driver OSs 164. In other words, the host OS 162 is an OS that manages the virtual machine system 160. The host OS 162 can operate also as the driver OS at the same time.

The guest OSs 163 are OSs that do not have an I/O (Input/Output) device as a configuration of the virtual machine, and are conventional OSs to be used by users.

The driver OSs 164 are OSs that control operations of an I/O device 166 as an external recording device such as a hard disk, a Read Only Memory (ROM) and the like, and an I/O device 167 for a connection with the network, while communicating with the guest OSs 163 via the virtual machine monitor 165. The driver OSs 164 actually execute the I/O devices 166 and 167. The guest OSs 163 execute the I/O devices 166 and 167 by issuing requests to the driver OSs 164. The driver OSs 164 can operate also on the host OS 162 and on the guest OSs 163. When the driver OSs 164 operate on the guest OSs 163, the driver OSs 164 serve as driver OSs of the corresponding guest OSs 163.

The virtual machine monitor 165 is a layer for controlling the entire virtual machine system 160, and controls dispatch of the respective OSs, emulation of privileged instructions executed by the respective OSs, and the hardware related to the CPU.

For example, when a user performs an operation to activate the host OS 162, the host OS 162 is activated, and an operation window of the host OS 162 is displayed on a display device 168 connected to the virtual machine system 160. When the user selects the activation of the guest OSs 163 on the operation window of the host OS 162, the guest OSs 163 are activated and the operation window of the guest OSs 163 is displayed on the display device 168. When the user selects the execution of the I/O device 166 on the display window of the guest OSs 163, an execution request of the I/O device 166 is issued from the guest OSs 163 to the virtual machine monitor 165 via a Frontend Driver 169, as shown in FIG. 2. Next, the execution request is issued to the I/O device 166 via a Backend Driver 170 and a real I/O driver 171 of the driver OS 164 from the virtual machine monitor 165, and the I/O device 166 is executed. The operation completion notice from the I/O device 166 is issued to the guest OSs 163 via the real I/O driver 171, the Backend Driver 170, the virtual machine monitor 165, and the Frontend Driver 169.

Based on the above virtual machine system 160, various virtual machines are conventionally realized.

For example, there is a technique in which a virtual machine is transferred between the virtual machine systems by including means which assigns common logic names to real machine resources of the respective virtual machines and manages the resources. (See the Patent Document 1, for example)

For example, there is also a technique in which hardware resources are virtually divided into two or more sections, two or more OSs simultaneously operating on the divided virtual hardware are prepared. This makes it possible to read and write a part of memory managed by arbitrary virtual hardware that is among the divided virtual hardware for an OS operating on other virtual hardware, hold it in memory the information for a failure recovery of software operated by an OS on other virtual hardware, and use the information for the failure recovery of the software. (See the Patent Document 2, for example)

However, in a virtual machine system as above, generally, one host OS is provided for a virtual machine system, and one driver OS is provided for an I/O device. Accordingly, communications between a guest OS and an I/O device can not be controlled when a failure occurs in a host OS or in a driver OS. Therefore, there is a problem that the virtual machine system cannot be operated after this type of failure, and the reliability of the virtual machine system is decreased.

As a method for solving this problem, it is possible that a spare host OS or a spare driver OS functioning similarly to the host OS or the driver OS is prepared in advance, and when a failure occurs in the current host OS or the current driver OS, the spare host OS or the spare driver OS takes over the processes and data of the current host OS and the current driver OS.

As a method of preparing the spare host OS or the spare driver OS, there is a method, for example, in which software for realizing the spare host OS or the spare driver OS is prepared in addition to software for realizing the current host OS or the current driver OS, thus the software for realizing the host OS or the driver OS is duplicated. It is also possible, for example, that hardware for realizing the spare host OS or the spare driver OS is prepared, and the hardware for realizing the host OS or the driver OS is duplicated.

As a method in which the spare host OS or the spare driver OS takes over the processes and data of the current host OS and the current driver OS when a failure occurs in the current host OS or in the current driver OS, a technique called fall over can be employed, for example.

By configuring a virtual machine system as above, even when a failure occurs in a current host OS or a current driver OS and communications between a guest OS and an I/O device cannot be controlled, it is possible that a spare host OS or a spare driver OS can take over the processes and data of the current host OS and the current driver OS, accordingly, the communication between the guest OS and the I/O device is not cut so that it is possible to suppress decrease of reliability of the virtual machine system.

Patent Document 1

Japanese Patent Application Publication No. 10-283210

Patent Document 2

Japanese Patent Application Publication No. 2001-101021

However, as stated above, there is a problem that it takes much cost of the virtual machine system to duplicate software and to duplicate hardware in the case that a spare host OS or a spare driver OS is prepared in advance by the duplication of software or by the duplication of hardware such that the spare host OS or the spare driver OS takes over the processes and data of the current host OS and of the current driver OS by fall over.

Further, when the spare host OS or the spare driver OS takes over the processes and data of the current host OS and the current driver OS, if the state of the spare host OS or of the spare driver OS is to be kept as late as possible, it is necessary that the change of state of the current host OS and the current driver OS is reflected on the spare host OS or the spare driver OS in advance. In order to have completed the reflection of the change of state on the spare host OS or on the spare driver OS before performing fall over, it is necessary to always monitor the change of state between the current host OS and the spare host OS or between the current driver OS and the spare driver OS, and to perform synchronization between data. Due to this necessity, the process such as above takes further cost of the virtual machine system.

### SUMMARY OF THE INVENTION

It is an object of the present invention to provide a virtual machine system to function with a suppressed cost, even when the spare host OS or the spare driver OS is prepared.

In order to achieve the above object, the present invention employs the configurations below.

The present invention provides a virtual machine system managed by a current host OS, virtually operating on hardware, that copies the current host OS to prescribed recording means (for example, a memory device such as RAM provided in the virtual machine system) provided in the virtual machine system when the current host OS is activated. A spare host OS, having the same function as that of the current host OS, is caused to operate on the hardware, and is notified of a request issued to the current host OS to change state. The virtual machine system switches an OS for managing the system from the current host OS to the spare host OS, when the current host OS gets in an erroneous state.

In the above configuration, is it possible to always keep the state of the spare host OS as the same as the state of the current host OS. Accordingly, even when the current host OS gets in an erroneous state, due to a failure occurring in the current host OS, the spare host OS can take over the process and data from the current host OS in the latest state as the host OS for managing the virtual machine system instantaneously. Therefore, the operation of the virtual machine system does not stop even when the current host OS gets in an erroneous state, and thereby being able to suppress the decrease of the reliability of the virtual machine system. Also, it is possible to suppress cost of the virtual machine system because the software or the hardware for providing the spare host is not duplicated and it is not necessary for the current host OS or the spare host OS to always monitor the state of each other, or to perform synchronization between data.

In the present invention, it is also possible to employ the configuration wherein, if a request issued to the current host OS is a request by which a state of the current host OS is changed, the spare host OS is notified of the request.

Thereby, it is possible to reduce the load on the virtual machine system compared to the configuration in which the spare host OS is notified of all the requests issued to the current host OS.

Additionally, the present invention provides a virtual machine system managed by a current host OS, virtually operating on hardware, that copies a current driver OS to prescribed recording means provided in the virtual machine system when the current driver OS for controlling operations of an I/O device provided in the virtual machine system is activated. The system causes a spare driver OS, having the same function as that of the current driver OS, to function on the hardware, notifies the spare driver OS of a request issued from a guest OS virtually operating on the hardware to the I/O device via the current driver OS, and changes a state of the spare driver OS. The system then notifies the spare driver OS of an operation completion notice issued from the I/O device to the guest OS via the current driver OS, changes a state of the spare driver OS. The system notifies, via the spare driver OS, the I/O device of a request issued from the guest OS, and further notifies, via the spare driver OS, the guest OS of the operation completion notice issued from the I/O device, when the current driver OS gets in an erroneous state.

Therefore, it is possible to always keep the state of the spare driver OS the same as the state of the current driver OS. Accordingly, the spare driver OS as a driver OS for controlling the I/O device can instantaneously take over the process and data of the current driver OS in the latest state even when a failure occurs in the current driver OS and the current driver OS gets in an erroneous state. Therefore, it is possible to suppress a decrease in the reliability of the virtual machine system because the communications between the guest OS and the I/O device are not cut even when the current driver OS gets in an erroneous state. Also, it is possible to suppress costs of the virtual machine system because the software or the hardware is not duplicated and it is not necessary for the current host OS or the spare host OS to always monitor the state of each other, or to perform synchronization between data.

In the present invention, it is also possible to employ the configuration in which the request issued from the guest OS to the I/O device via the spare driver OS is discarded, and the operation completion notice issued from the I/O device to the guest OS via the spare driver OS is discarded, when the current driver OS is not in an erroneous state.

In the present invention, it is also possible to employ the configuration in which a request for an answer is issued to the current host OS or the current driver OS and it is determined that the current host OS or the current driver OS is in an erroneous state when the answer corresponding to the request for an answer is not issued from the current host OS or the current driver OS within a prescribed time period.

According to the present invention, it is possible to construct the virtual machine system with a reduced cost even when the spare host OS and the spare driver OS are prepared.

### BRIEF DESCRIPTION OF THE DRAWINGS

FIG. 1 shows a conventional virtual machine system;

FIG. 2 shows a relationship among a guest OS, a driver OS, and a virtual machine monitor in the conventional virtual machine system;

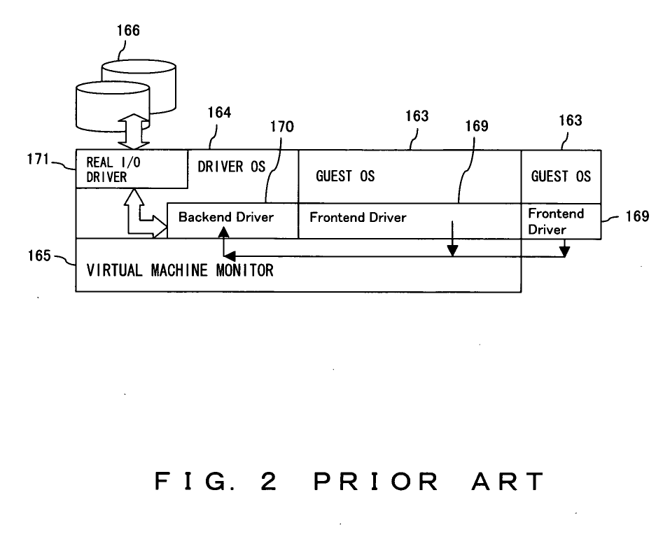

FIG. 3 is a principle view of a virtual machine system for realizing duplication of a host OS, according to an embodiment of the present invention;

FIG. 4 is a view for explaining a live migration function;

FIG. 5 is a flowchart of operation of the virtual machine system for always keeping a state of a spare host OS the same as a state of a current host OS;

FIG. 6 is a flowchart of operation of the virtual machine system for causing the spare host OS to take over processes and data from the current host OS;

FIG. 7 is a principle view of the virtual machine system for realizing duplication of the driver OS, according to the embodiment of the present invention;

FIG. 8 shows a relationship among a guest OS, a current driver OS, and a spare driver OS;

FIG. 9 is a flowchart of operations of the virtual machine system for always keeping the state of the spare driver OS the same as the state of the current driver OS;

FIG. 10 shows a request issued from the guest OS to the virtual machine monitor;

FIG. 11 shows an instruction issued from the virtual machine monitor to the I/O device;

FIG. 12 shows an operation completion notice issued from the virtual machine monitor to the driver OS;

FIG. 13 is a flowchart of operations of the virtual machine system for causing the spare driver OS to take over process and data from the current driver OS;

FIG. 14 shows the virtual machine system in the case when the current driver OS gets in an erroneous state;

FIG. 15 shows the virtual machine system in the case when the current driver OS gets in an erroneous state;

FIG. 16 shows an example of a hardware configuration of the virtual machine system according to the present embodiment; and

FIG. 17 shows an example of a recording media in the case when the virtual machine system according to the present embodiment is configured as a recording medium.

### DESCRIPTION OF THE PREFERRED EMBODIMENTS

Hereinbelow, the embodiment of the present invention will be explained, by referring to the drawings.

First, the configuration for realizing the duplication of the host OS is explained.

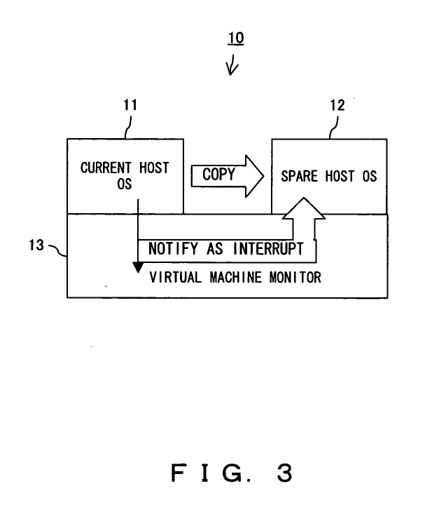

FIG. 3 is a principle view of a virtual machine system according to the embodiment of the present invention, showing a virtual machine system for realizing the duplication of the host OS.

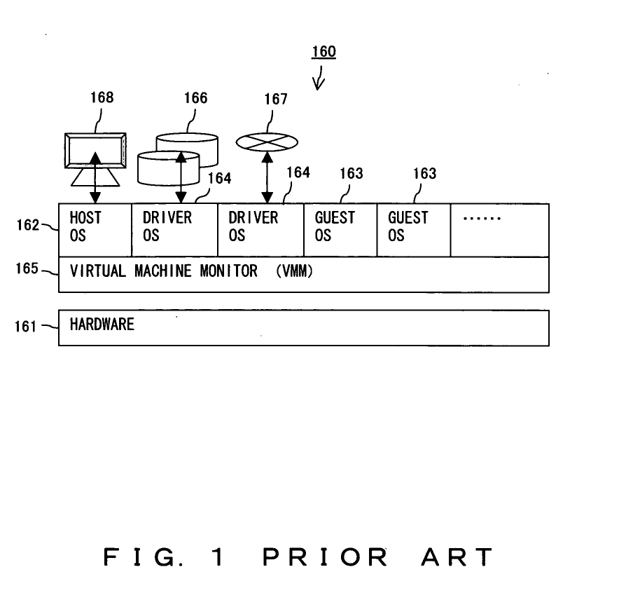

A virtual machine system 10 shown in FIG. 3 comprises a current host OS 11 that operates, as a virtual machine, on the hardware such as a CPU or the like, and that manages the virtual machine system 10. The system further comprises a spare host OS 12 that operates, as the virtual machine, on the hardware and takes over processes and data of the current host OS 11 when the current host OS 11 gets in an erroneous state (for example, when the current host OS 11 halts due to too a heavy load on the current host OS 11). The system also comprises a virtual machine monitor 13 which operates on the hardware and controls the operation of the current host OS 11 or of the spare host OS 12. The virtual machine system 10 shown in FIG. 3 comprises, although not shown, a guest OS 163, a driver OS 164, I/O devices 166 and 167, and the like, similarly to the virtual machine system 160 shown in FIG. 1. The spare host OS 12 operates on a virtual machine other than the one on which the current host OS 11 operates. In some embodiments, it is desirable that the resource (harddisk, memory device and the like) necessary for preparing the current host OS 11 and the resources necessary for preparing the spare host OS 12 are not used in common if the reliability of the virtual machine system 10 is to be increased. However, it is possible to use them in common.

The current host OS 11 is activated when a program and data necessary for operating the current host OS 11 are read from a recording unit such as a hard disk or the like, and the read program and data are written to a memory device such as RAM included in the virtual machine system 10.

The spare host OS 12 is activated when the program and data of the current host OS 11 on the above memory device is copied to another memory device by a live migration function or the like after the current host OS 11 is activated. Because of this, for example, when the current host OS 11 is Linux, the spare host OS 12 of the current host OS 11 becomes also Linux.

The virtual machine monitor 13 also usually (when the current host OS 11 is not in an erroneous state) notifies the spare host OS 12 of a request to the current host OS 11 as an interrupt, and switches the OS for managing the virtual machine system 10 from the current host OS 11 to the spare host OS 12 when the current host 11 gets in an erroneous state.

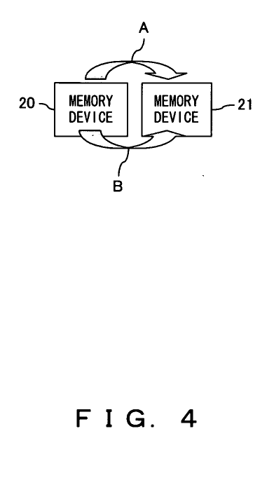

FIG. 4 is a view for explaining the above live migration function.

The live migration function is basically a function of copying contents of a memory device 20 used on one virtual machine to a memory device 21 used on another virtual machine, as described above, by which the contents of the memory device 20 can be copied to the memory device 21 even when the virtual machine as the copy source is operating (arrow “A” of FIG. 4). Accordingly, even if the configuration is employed wherein the program and data necessary for operating the current host OS 11 are written to the memory device 20 and the current host OS 11 is activated, and the program and data in the memory device 20 are copied to the memory device 21 by the live migration function in order to operate the spare host OS 12, the operation of the current host OS 11 does not stop. Additionally, by the live migration function, it is possible to switch from the virtual machine of the copy source to the virtual machine of the copy destination at an arbitrary timing (arrow “B” of FIG. 4). Furthermore, by the live migration function, it is possible to copy the virtual machine and to switch from one virtual machine to another between two memory devices regardless of whether the two memory devices are included in one computer or the two memory devices are respectively included in different computers. Therefore, it is possible that the spare host OS 12 is activated on the computer on which the current host OS 11 operates, or on a computer other than the computer on which the current host OS 11 operates.

It is also possible that the spare host OS 12 is configured to have a function of copying between memory devices other than the live migration function.

Next, the operation of the virtual machine system 10 is explained wherein the state of the spare host OS 12 is kept the same as the state of the current host OS 11 after the spare host OS 12 is prepared.

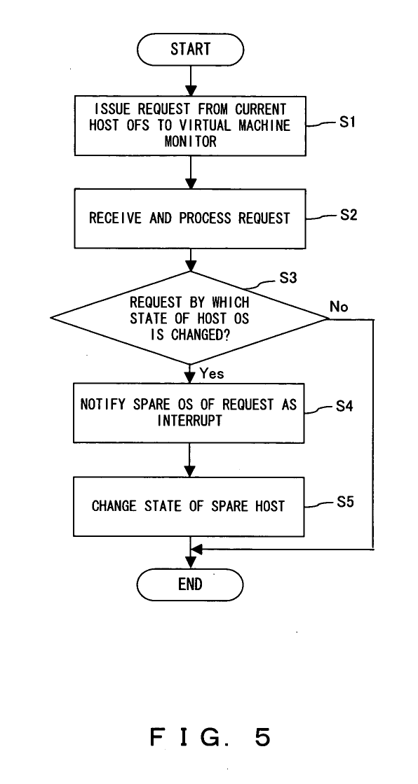

FIG. 5 is a flowchart of operation of the virtual machine system 10 for always keeping the state of the spare host OS 12 the same as the state of the current host OS 11.

First, the current host OS 11 issues a request to the virtual machine monitor 13 (step S1). For example, the current host OS 11 issues a request of activating a new guest OS to the virtual machine monitor 13 by a Hypervisor call instruction.

Next, upon receiving the above request, the virtual machine monitor 13 processes the request (step S2). For example, upon receiving the request of activating a new guest OS 163, the virtual machine monitor 13 performs the process of activating a new guest OS.

Next, the virtual machine monitor 13 determines whether or not the request is the request by which the state of the current host OS 11 is changed (step S3). Examples of the request by which the state of the current host OS 11 is changed include requests by which contents which are to be managed by the current host OS 11 are changed, such as a request of activating a new guest OS, and/or a request of terminating a driver OS and the like. Also, examples of the request by which the state of the current host OS 11 is not changed include the request by which the contents which are to be managed by the current host OS 11 are not changed, such as a request of displaying a list of guest OSs on a display device and the like.

When it is determined that the request is the request by which the state of the current host OS 11 is not changed (No at step S3), the virtual machine system 10 terminates the process of always keeping the sate of the spare host OS 12 the same as the state of the current host OS 11.

When it is determined that the request is the request by which the state of the current host OS 11 is changed (Yes at step S3), the virtual machine monitor 13 notifies the spare OS 12 of the above request as an interrupt (step S4).

When the spare host OS 12 receives the above request of which the host OS 12 is notified as an interrupt, the spare host OS 12 changes the state of the host OS 12 itself based on the request (step S5), and the virtual machine system 10 terminates the process of always keeping the state of the spare host OS 12 the same as the state of the current host OS 11. For example, when receiving the request of activating a new guest OS, the spare host OS 12 adds the new guest OS to the list of the guest OSs which are managed currently.

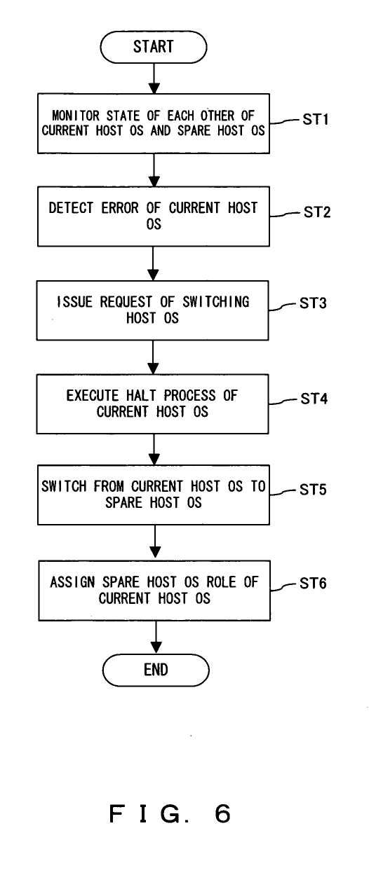

FIG. 6 is a flowchart of operation of the virtual machine system 10 for causing the spare host OS 12 to take over processes and data from the current host OS 11.

First, the current host OS 11 and the spare host OS 12 monitor the state of each other at a prescribed time interval (step ST1). Examples of methods of monitoring the state of each other include a method of monitoring each other by communicating between the current host OS 11 and the spare host OS 12 using a LAN (Local Area Network) or the like.

Next, the spare host OS 12 detects an error of the current host OS 11 (step ST2). For example, it is possible to have the configuration in which the spare host OS 12 issues to the current host OS 11 a request for an answer, and if the answer to the request is not issued from the current host OS 11 within a prescribed time period (for example, five seconds or ten seconds), it is determined that the current host OS 11 got in an erroneous state.

Next, when detecting the error of the current host OS 11, the spare host OS 12 issues to the virtual machine monitor 13 a request of switching of the host OSs (step ST3).

Next, when receiving the request of switching the host OSs, the virtual machine monitor 13 issues, to the current host OS 11, a halt request (step ST4). When receiving the halt request, the current host OS 11 performs a halt process.

Next, the virtual machine monitor 13 performs processes of switching the destination of all the requests from the current host OS 11 to the spare host OS 12 (step ST5).

Then, the spare host OS 12 is assigned the role of the current host OS 11, and manages the virtual machine system 10 (step ST6).

In the above configuration, is it possible to always keep the state of the spare host OS 12 the same as the state of the current host OS 11. Accordingly, even when the current host OS 11 gets in an erroneous state due to a failure occurring in the current host OS 11, the spare host OS 12 can take over the process and data from the current host OS 11 in the latest state as the host OS for managing the virtual machine system 10 instantaneously. Thereby, the operation of the virtual machine system 10 does not stop even when the current host OS 11 gets in an erroneous state, such that it is possible to suppress the decrease of the reliability of the virtual machine system 10.

Additionally, compared to the conventional case where spare OSs are prepared in advance by duplication of software or duplication of hardware in order that the spare OS takes over processes and data of the current host OS by the fall over, it is possible to suppress cost of the virtual machine system 10 because the software or the hardware is not duplicated and it is not necessary for the current host OS 11 or the spare host OS 12 to always monitor the state of each other, or to perform synchronization between data.

In the above embodiment, the configuration is employed as shown in the flowchart of FIG. 5, in which when the request issued to the current host OS 11 is the request by which the current host OS 11 is changed (Yes at step S3 of FIG. 5), the spare host OS 12 is notified of the request (step S4 of FIG. 5). However, it is also possible to have the configuration in which the step S3 of FIG. 5 is omitted, and the spare host OS 12 is notified of all the requests issued to the current host OS 11 and the state of the spare host OS 12 is changed. As in the flowchart of FIG. 5, with the configuration in which the spare host OS 12 is notified of only the request by which the state of the current host OS 11 is changed, it is possible to reduce the load on the spare host OS 12 and on the virtual machine monitor 13, and to reduce the load on the virtual machine system 10, compared to the configuration in which the spare host OS 12 is notified of all the requests issued to the current host OS 11.

Next, the configuration of realizing the duplication of the driver OS will be explained.

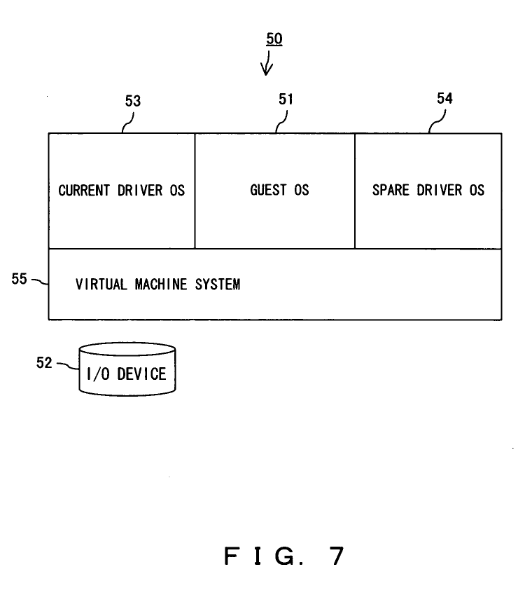

FIG. 7 shows a virtual machine system according to another embodiment of the present invention, which is for realizing the duplication of the driver OS.

A virtual machine system 50 shown in FIG. 7 comprises a guest OS 51 operating as a virtual machine on hardware such as a CPU or the like, an I/O device 52, and a current driver OS 53 that operates on the above hardware as the virtual machine and that performs the I/O control between the guest OS 51 and the I/O device 52. The system further comprises a spare driver OS 54 that operates as the virtual machine on the hardware and that takes over the processes and data of the current driver OS 53 when the current driver OS 53 gets in an erroneous state (for example, when the current driver OS 53 halts due to a too heavy load on the current driver OS 53). Additionally, a virtual machine monitor 55 that controls operations of the guest OS 51, the I/O device 52, the current driver OS 53, and the spare OS 54 are included in the present embodiment. The virtual machine system 50 shown in FIG. 7 also comprises, although not shown, the host OS 162 and the like similarly to the virtual machine system 160 shown in FIG. 1. The spare driver OS 54 operates on a different virtual machine than the one on which the current driver OS 53 operates. The resource, such as a hard disk or the like, for storing the program and data for operating the current driver OS 53, and the resources, such as a hard disk or the like, for storing the program and data for operating the spare driver OS 54 are commonly used.

When the current driver OS 53's operating program and data are written to a memory device such as RAM or the like, in order to activate the current driver OS 53, the spare driver OS 54 is activated when the current driver OS 53's program and data on the corresponding memory device are copied to a memory device managed by another virtual machine using the live migration function or the like, similarly to the duplicate of the above host OS.

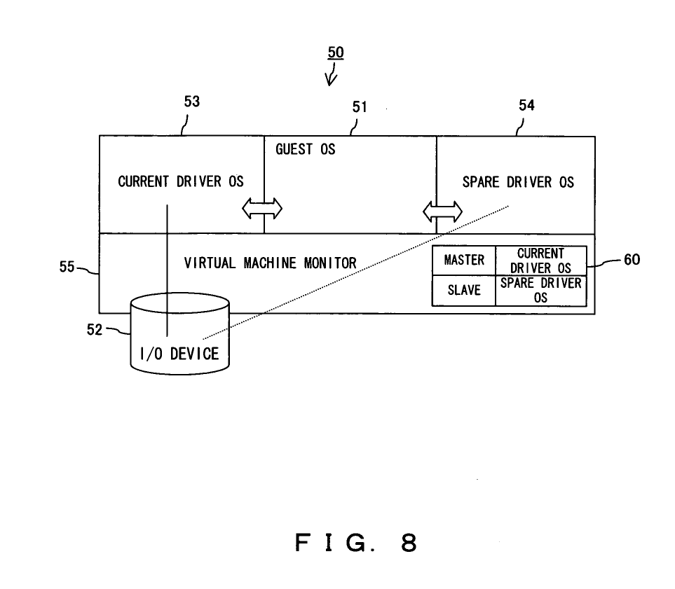

As shown in FIG. 8, the above virtual machine monitor 55 is comprised of data 60 specifying the definition of the master-slave relationship between the current driver OS 53 and the spare driver OS 54. It notifies the I/O device 52 of a request from guest OS 51 via the current driver OS 53 or the spare driver OS 54, and gives the operation completion notice from the I/O device 52 to the guest OS 51 via the current driver OS 53 or the spare driver OS 54. In other words, the link between the current driver OS 53 and the guest OS 51 is established, and another link between the spare driver OS 54 and the guest OS 51 is also established.

Next, the operation of the virtual machine system 50 for maintaining the state of the spare driver OS 54 the same as the current driver OS 53 will be explained.

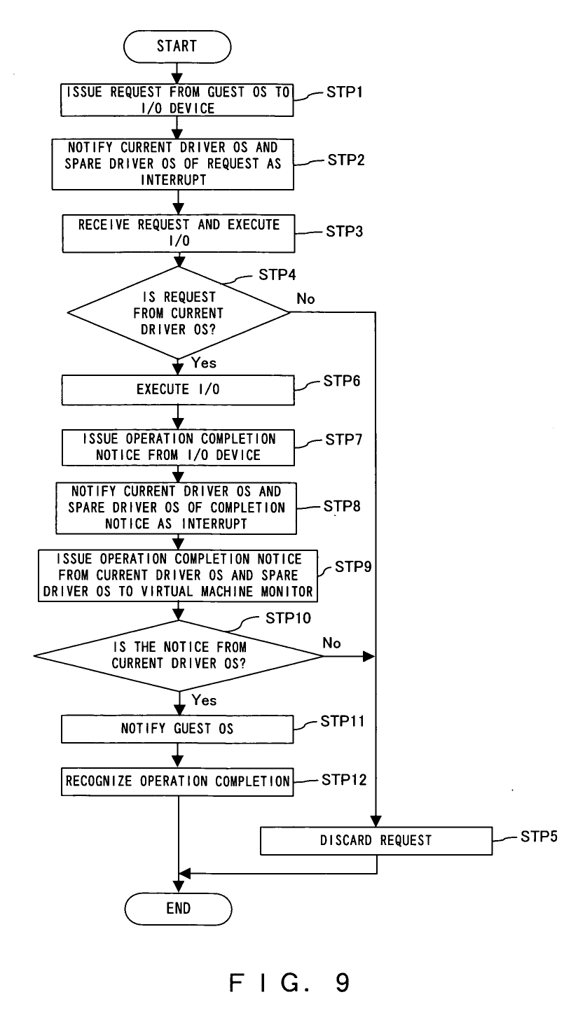

FIG. 9 is a flowchart of the virtual machine system 50′ operation for keeping the state of the spare driver OS 54 the same as the current driver OS 53.

First, the guest OS 51 issues a request to operate the I/O device 52 to the virtual machine monitor 55 (step STP1).

Next, the virtual machine monitor 55 notifies the current driver OS 53 and the spare driver OS 54 of the above request as an interrupt (step STP2).

Next, the current driver OS 53 and the spare driver OS 54 receive the above request and issue instructions based on the above request to the virtual machine monitor 55 (step STP 3).

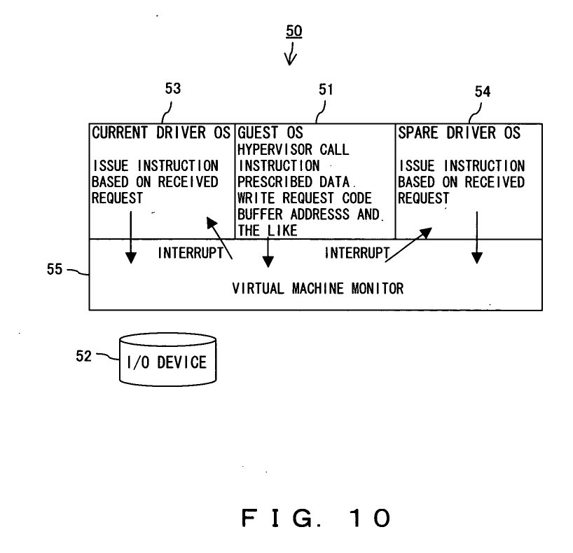

Here, the case is explained wherein the request from guest OS 51 is issued for writing prescribed data for the I/O device 52, which is a buffer memory device. As shown in FIG. 10, first, the guest OS 51 issues the request comprising the prescribed data, a write request code, an address, and the like to the virtual machine monitor 55 by a Hypervisor call instruction. Next, when receiving the request, the virtual machine monitor 55 notifies the current driver OS 53 and the spare driver OS 54 of the request as an interrupt. Then, the current driver OS 53 and the spare driver OS 54 respectively issue to the virtual machine monitor 55 the instructions to write the prescribed data to the I/O device 52 based on the received request.

Next, in FIG. 9, the virtual machine monitor 55 determines if the received instruction is from the current driver OS 53 (step STP4).

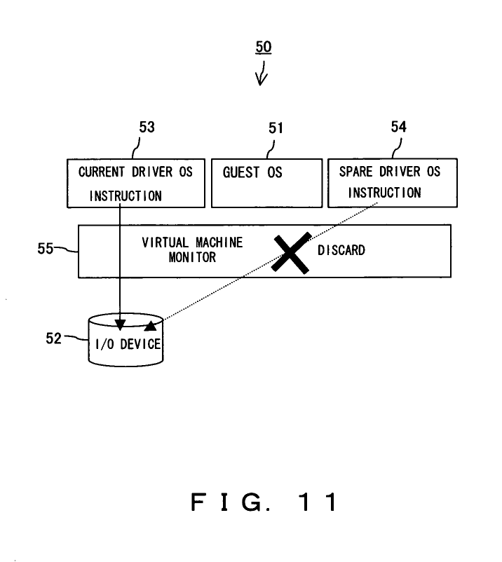

When it is determined that the received instruction is not from the current driver OS 53 (No at step STP4), the virtual machine monitor 55 discards the received instruction as shown in FIG. 11 (step STP5).

When it is determined that the received instruction is from the current driver OS 53 (Yes at step STP4), the virtual machine monitor 55 notifies the I/O device 52 of the above instruction as shown in FIG. 11 (step STP6).

Next, the virtual machine monitor 55 receives the operation completion notice issued by the I/O device 52 (step STP7).

Next, the virtual machine monitor 55 notifies the current driver OS 53 and the spare driver OS 54 of the above operation completion notice (step STP8).

Next, the current driver OS 53 and the spare driver OS 54 respectively issue the operation completion notice to the virtual machine monitor 55 in order to notify the guest OS 51 (step STP9). For example, the current driver OS 53 and the spare driver OS 54 respectively issue the operation completion notice to the virtual machine monitor 55 by the Hypervisor call instruction.

Next, the virtual machine monitor 55 determines whether or not the received operation completion notice is from the current driver OS 53 (step STP10).

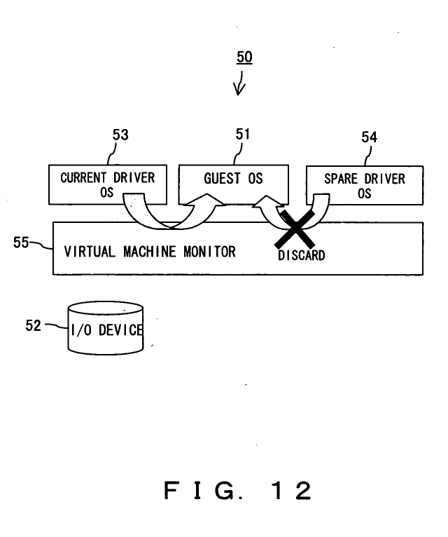

When it is determined that the received operation completion notice is not the notice issued from the current driver OS 53 (No at step STP10), the virtual machine monitor 55 discards the received operation completion notice as shown in FIG. 12 (step STP5).

When it is determined that the received operation completion notice is the notice issued from the current driver OS 53 (Yes at step STP10), the virtual machine monitor 55 notifies the guest OS 51 of the received operation completion notice as shown in FIG. 12 (step STP11).

Then, the guest OS 51 recognizes that the I/O device 52 has completed the operation (step STP12), and the virtual machine system 50 terminates the process for keeping the state of the spare driver OS 54 the same as the current driver OS 53.

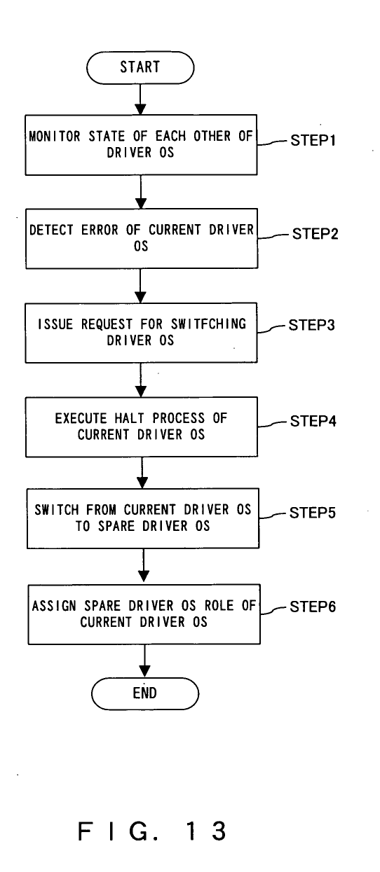

FIG. 13 is a flowchart of the virtual machine system 50's operation for making the spare driver OS take over the process and data from the current driver OS.

First, the current driver OS 53 and the spare driver OS 54 monitor each other at a prescribed time interval (step STEP1). For example, the above monitoring can be realized by communications between the current driver OS 53 and the spare driver OS 54 using a LAN or the like.

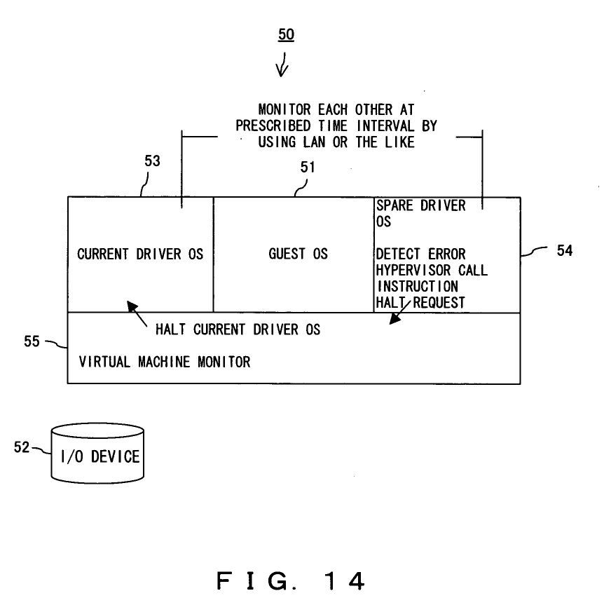

Next, the spare driver OS 54 detects the error in the current driver OS 53 (step STEP2). For example, as shown in FIG. 14, it is possible to have a configuration in which the spare host OS 54 issues a request for answer to the current driver OS 53. If the answer to the request is not issued from the current driver OS 53 within a prescribed time period (for example, five seconds or ten seconds), it is determined that the current driver OS 53 is in an erroneous state.

Next, when detecting the error in the current driver OS 53, the spare driver OS 54 issues a request of switching the driver OSs to the virtual machine monitor 55 (step STEP3).

Next, when receiving the request of switching driver Oss, the virtual machine monitor 55 notifies the current driver OS 53 of the halt request (step STEP4). The current driver OS 53 performs a halt process after receiving the halt request.

Next, the virtual machine monitor 55 counterchanges the definition of the master-slave relationship between the current driver OS 53 and the spare driver OS 54 specified by the data 60, notifies the I/O device 52 of the request issued from the guest OS 51 via the spare driver OS 54, and notifies, via the spare driver OS 54, the guest OS 51 of the operation completion notice issued from the I/O device 52 (step STEP5).

Then, the spare driver OS 54 is assigned the role of the current driver OS 53 (step STEP6).

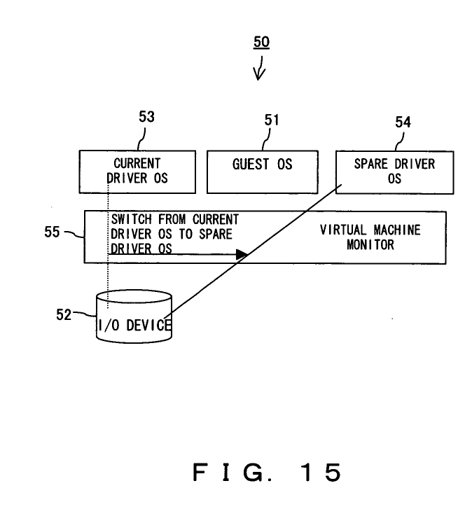

Here, the case is explained, wherein the spare driver OS 54 detects the error in the current driver OS 53, and the virtual machine monitor 55 halts the current driver OS 53, for example. As shown in FIG. 14, first, the spare driver OS 54, when detecting the error in the current driver OS 53, issues to the virtual machine monitor 55, a request of switching the driver OS by the Hypervisor call instruction. Next, when receiving the switching request, the virtual machine monitor 55 notifies the current driver OS 53 of the halt request. Then, as shown in FIG. 15, the virtual machine monitor 55 switches the driver OS for controlling the communications between the guest OS 51 and the I/O device 52 from the current driver OS 53 to the spare driver OS 54. Also, the virtual machine monitor 55 issues, to the I/O device 52 via the spare driver OS 54 (the spare driver OS 54 which is assigned the role of the current driver 53 at step STEP6), the request issued from the guest OS 51, and notifies the guest OS 51 of the operation completion notice issued from the I/O device 52 via the spare driver OS 54.

Thus, it is possible to always keep the state of the spare driver OS 54 the same as the current driver OS 53. Accordingly, the spare driver OS 54 as a driver OS for controlling the I/O device 52 can instantaneously take over the process and data of the current driver OS 53 in the latest state, even when a failure occurs in the current driver OS 53 and the current driver OS 53 is in an erroneous state. Therefore, it is possible to suppress the reliability decrease of the virtual machine system 50 because communications between the guest OS 51 and the I/O device 52 are not cut even when the current driver OS 53 is in an erroneous state.

It is also possible to suppress cost for the virtual machine system 50, because software or hardware is not duplicated for preparing the spare driver OS 54 and it is not necessary for the current driver OS 53 or the spare driver OS 54 to always monitor change of state of each other, or to perform synchronization between data.

In the above embodiment, the virtual machine system 10 and the virtual machine system 50 are separately explained as the duplication configuration of the host OS and the duplication of the driver OS. However, it is possible to construct the virtual machine system 10 and the virtual machine system 50 in the same virtual machine system.

In the above embodiment, the configuration employed shows the host OS and the driver OS respectively duplicated. However, it is possible to employ respective triplication or further of the host OS and the driver OS.

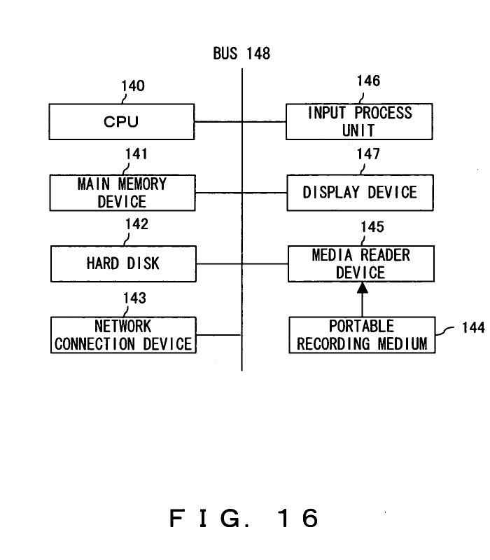

FIG. 16 shows an example of a hardware configuration of the virtual machine system 10 and the virtual machine system 50 according to the present embodiment.

As shown in FIG. 16, the configuration of the virtual machine system 10 and the virtual machine system 50 is comprised of a CPU 140, a memory device 141, a hard disk 142, a network connection device 143 such as a modem, a LAN adapter or the like, a portable recording medium 144 such as a CD (Compact Disc), a DVD (Digital Versatile Disk), an optical disk, a flexible disk or the like, a media reader device 145, an input process unit 146, and a display device 147, which are connected one another via a bus 148.

The respective processes performed by the virtual machine system 10 and the virtual machine system 50 are realized when the CPU 140 reads the program and data recorded in the hard disk 142, loads this program and data to the memory device 141, and executes them.

Between the virtual machine system 10 and the virtual machine system 50, the program and data may be exchanged by using the portable recording medium 144. Accordingly, the virtual machine system 10 and the virtual machine system 50 according to the present embodiment can be configured as a computer readable recording medium for causing the computer to execute the respective processes in the above embodiment.

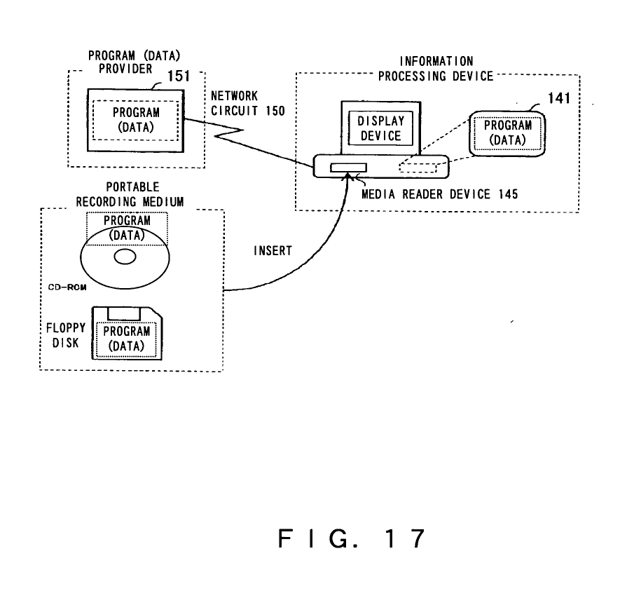

FIG. 17 shows an example of the recording medium when the virtual machine system 10 and the virtual machine system 50 according to the present embodiment are configured as the recording medium.

As shown in FIG. 17, examples of the recording medium include a recording device 151, which is connected via a network circuit 150 and is owned by an external information provider, in addition to the above portable recording medium 144 such as a CD-ROM, a flexible disk, a MO (Magneto Optical) disk, a DVD, a removable magnetic disk and the like, the above hard disk 142 and the above memory device 141. The program and data recorded in the portable recording medium 144 and the recording device 151 are loaded to the memory device 141, executed, and realize the respective processes of the above virtual machine system 10 and the virtual machine system 50.

What is claimed is:

1. A computer readable recording medium recording a program for causing a computer, in order to control operations of a virtual machine system managed by a current host OS virtually operating on a hardware, to function as:
means for copying the current host OS to prescribed recording means provided in the virtual machine system when the current host OS is activated, and for causing a spare host OS having the same function as that of the current host OS to operate on the hardware;
means for notifying the spare host OS of a request issued to the current host OS, and for changing a state of the spare host OS; and
means for switching an OS for managing the virtual machine system from the current host OS to the spare host OS when the current host OS gets in an erroneous state.

2. The computer readable recording medium, according to claim 1, recording a program causing a computer to function as:
means for notifying, when a request issued to the current host OS is a request where a state of the current host OS is changed, the spare host OS of the request.

3. A computer readable recording medium recording a program for causing a computer, in order to control operations of a virtual machine system managed by a current host OS virtually operating on a hardware, to function as:
means for copying a current driver OS to prescribed recording means provided in the virtual machine system when the current driver OS controlling operations of an I/O device provided in the virtual machine system is activated, and causing a spare driver OS having the same function as that of the current driver OS to function on the hardware;
means for notifying the spare driver OS of a request issued from a guest OS virtually operating on the hardware to the I/O device via the current driver OS, and for changing a state of the spare driver OS;
means for notifying the spare driver OS of an operation completion notice issued from the I/O device to the guest OS via the current driver OS, and for changing a state of the spare driver OS; and
means for notifying, via the spare driver OS, the I/O device of a request issued from the guest OS, and notifying, via the spare driver OS, the guest OS of the operation completion notice issued from the I/O device, when the current driver OS is in an erroneous state.

4. The computer readable recording medium, according to claim 3, recording a program causing a computer to function as:
means for discarding the request issued from the guest OS to the I/O device via the spare driver OS, and discarding the operation completion notice issued from the I/O device to the guest OS via the spare driver OS, when the current driver OS is not in an erroneous state.

5. The computer readable recording medium, according to claim 1, recording a program for causing a computer to function as:
means for issuing, to the current host OS, a request for an answer, and for determining that the current host OS is in an erroneous state when the answer corresponding to the request for an answer is not issued from the current host OS within a prescribed time period.

6. The computer readable recording medium, according to claim 3, recording a program for causing a computer to function as:
means for issuing, to the current driver OS, a request for an answer, and for determining that the current driver OS is in an erroneous state when the answer corresponding to the request for an answer is not issued from the current driver OS within a prescribed time period.

7. A virtual machine system managed by a current host OS virtually operating on a hardware, comprising:
means for copying the current host OS to prescribed recording means provided in the virtual machine system when the current host OS is activated, and for causing a spare host OS having the same function as that of the current host OS to operate on the hardware;
means for notifying the spare host OS of a request issued to the current host OS, and for changing a state of the spare host OS; and
means for switching an OS for managing the virtual machine system from the current host OS to the spare host OS, when the current host OS gets in an erroneous state.

8. The virtual machine system according to claim 7, comprising:
means for notifying, when a request issued to the current host OS is a request where the state of the current host OS is changed, the spare host OS of the request.

9. A virtual machine system managed by a current host OS virtually operating on a hardware, comprising:
means for copying a current driver OS to prescribed recording means provided in the virtual machine system when the current driver OS for controlling operations of an I/O device provided in the virtual machine system is activated, and for causing a spare driver OS having the same function as that of the current driver OS to function on the hardware;
means for notifying of the spare driver OS of a request issued from a guest OS virtually operating on the hardware to the I/O device via the current driver OS, and for changing a state of the spare driver OS;
means for notifying the spare driver OS of an operation completion notice issued from the I/O device to the guest OS via the current driver OS, and for changing a state of the spare driver OS; and
means for notifying, via the spare driver OS, the I/O device of a request issued from the guest OS and notifying, via the spare driver OS, the guest OS of the operation completion notice issued from the I/O device when the current driver OS is in an erroneous state.

10. The virtual machine system according to claim 9, comprising:
means for discarding the request issued from the guest OS to the I/O device via the spare driver OS, and discarding the operation completion notice issued from the I/O device to the guest OS via the spare driver OS when the current driver OS is not in an erroneous state.

11. The virtual machine system according to claim 7, comprising:
means for issuing, to the current host OS, a request for an answer and determining that the current host OS is in an erroneous state when the answer corresponding to the request for an answer is not issued from the current host OS within a prescribed time period.

12. The virtual machine system according to claim 9, comprising:
means for issuing, to the current driver OS, a request for an answer, and for determining that the current driver OS is in an erroneous state when the answer corresponding to the request for an answer is not issued from the current driver OS within a prescribed time period.
